(19) United States
(12) Patent Application Publication
(10) Pub. No.: US 2014/0139434 A1
(43) Pub. Date: May 22, 2014

(54) INPUT DEVICE, INPUT SYSTEM, INFORMATION PROCESSING SYSTEM, COMPUTER-READABLE STORAGE MEDIUM HAVING STORED THEREON INFORMATION PROCESSING PROGRAM, AND INFORMATION PROCESSING METHOD

(71) Applicant: Shoji MASUBUCHI, Kyoto-shi (JP)

(72) Inventor: Shoji MASUBUCHI, Kyoto-shi (JP)

(21) Appl. No.: 13/937,723

(22) Filed: Jul. 9, 2013

(30) Foreign Application Priority Data
Nov. 22, 2012 (JP) 2012-256049

(51) Int. Cl. G06F 3/0354

(52) U.S. Cl. CPC G06F 3/0354
USPC 345/161

(57) ABSTRACT

An example input device or the like includes: an input member; a sensing member for sensing a direction of an input operation conducted against the input member; a disposition member on which the sensing member is disposed; and a data processor capable of processing sense data sensed based on the sensing member and outputting output data of a predetermined output direction. The sensing member is disposed on the disposition member such that the direction sensible by the sensing member is rotated by a predetermined rotation angle with respect to the predetermined output direction, and the data processor is configured to execute an arithmetic process of rotational conversion to rotate the sense data in a direction opposite of a rotation direction of the predetermined rotation angle to output of the result of the arithmetic process as output data.

### CROSS REFERENCE TO RELATED APPLICATION

The disclosure of Japanese Patent Application No. 2012-256049, filed on Nov. 22, 2012, is incorporated herein by reference.

### FIELD

The exemplary embodiments described herein relate to input devices and the like, and more specifically, relate to stick type input devices.

### BACKGROUND AND SUMMARY

Hitherto known examples of input devices include those that are referred to as a pointing stick. The pointing stick is used on information processing equipment etc., such as personal computers, and is used as a signal input device for determining positions and controlling motion of a cursor or the like on a display screen. Specifically, when a strain sensor is disposed as a representative sensor on the lower part of an operation stick of a pointing stick and when the operation stick is tilted to cause strain on the strain sensor, magnitude of the tilting in accordance with an amount of strain is sensed. Furthermore, since it is possible to sense operational changes in opposing directions when the strain sensors are placed as a pair so as to oppose each other, pairs of sensors are typically opposingly disposed independently in each direction to enable sensing of operational changes in, for example, up-down direction and right-left direction. Sensing results from strain sensors in each of the directions are combined for sensing the magnitude and direction of the tilting of the operation stick.

However, since it is not possible to mechanistically limit the range of input in a conventional analog input device such as the pointing stick described above, when an excessive load (input) is applied, analog data of the load sensed by a sensor is amplified by an amplifier and analog-to-digital converted with a predetermined resolution to possibly cause an output value of converted digital data to reach an upper limit (saturation occurring in sensor, amplifier, or analog-to-digital conversion mechanism). Therefore, for example, on a pointing stick including the same type of sensors for sensing operations in both the right-left direction (x-axis direction) and the up-down direction (y-axis direction), when an operator conducts a strong input, for example, in the upward direction (y-axis positive direction) but also slightly in the rightward direction (x-axis positive direction), the sensors may become saturated to obtain the same output values in the x-axis direction and the y-axis direction (output upper limit value). In this case, when the output values in the x-axis direction and the y-axis direction are combined, the output direction outputted as the direction of the tilting of the operation stick is calculated as a direction 45 degrees counterclockwise from the positive direction of the x-axis. Therefore, even though the operator has conducted an input with respect to the operation stick in a direction almost upward, the output direction is calculated as a 45 degree diagonal right-upward direction, and the difference between the actual input direction and the output direction outputted as a calculation result becomes unintendedly large.

Thus, on a pointing stick having sensors for sensing operational changes in both the up-down direction and the right-left direction, even when actually an input of a large load is applied almost in the up-down direction or the right-left direction, the output direction outputted as the direction of the tilting of the operation stick is unintendedly calculated as a diagonal direction. As a result, a problem occurs where the feel of operation deteriorates for an operator who commonly conducts inputs in four directions frequently.

Therefore, a main object of the embodiments described herein is to provide an input device or the like for improving the feel of operation.

The above described object is achieved by, for example, a configuration described below.

An input device according to the present embodiment comprises: an input member; a sensing member configured to sense a direction of an input operation conducted against the input member; a disposition member on which the sensing member is disposed; and a data processor capable of processing sense data sensed based on the sensing member and outputting output data of a predetermined output direction. Furthermore, the sensing member is disposed on the disposition member such that the direction sensible by the sensing member is rotated by a predetermined rotation angle with respect to the predetermined output direction, and the data processor is configured to execute an arithmetic process of rotational conversion to rotate the sense data in a direction opposite of a rotation direction of the predetermined rotation angle to output a result of the arithmetic process as output data.

With the above described configuration, although the direction sensible by the sensing member is different from the predetermined output direction of the predetermined rotation angle, it is possible to output the output data of the predetermined output direction by executing an arithmetic process of rotational conversion to rotate the sense data in a direction opposite of the rotation angle. Therefore, since it is not necessary to match the predetermined output direction and the direction sensible by the sensing member, an input device capable of providing improved feel of operation can be obtained by flexibly setting a predetermined rotation angle.

Furthermore, the input device may further comprise a converter configured to conduct analog-to-digital conversion of analog data at a predetermined resolution. In this case, the sense data is data obtained through analog-to-digital conversion by the converter conducted on analog data sensed by the sensing member.

In the above described configuration, since the sense data is data obtained through analog-to-digital conversion conducted on analog data by a predetermined resolution, when a value of the analog data sensed by the sensing member is large (i.e., when a large input is made to the input device), the sense data in a direction sensible by the sensing member may reach an upper limit value (saturation may occur in the converter or the sensing member for sensing a change in the direction). In this case, since the direction whose output value becomes constant due to saturation occurred in the sensing member (i.e., input direction sensible by the sensing member) is different from the predetermined output direction by the predetermined rotation angle, the direction whose output value becomes constant can be set as a direction matching the predetermined output direction by setting the rotation angle to a predetermined angle. Therefore, an input device capable of providing improved feel of operation can be obtained by flexibly setting the predetermined rotation angle.

Furthermore, the data processor may execute an arithmetic process of rotational conversion to rotate the sense data in a direction opposite of a rotation direction of the predetermined rotation angle by a degree identical to the predetermined rotation angle, and may output the output data.

With the above described configuration, although the direction sensible by the sensing member is different from the predetermined output direction of the predetermined rotation angle, it is possible to output the output data of the predetermined output direction by executing an arithmetic process of rotational conversion to rotate the sense data in a direction opposite of the rotation angle by a degree identical to the rotation angle. Therefore, even without matching the predetermined output direction and the direction sensible by sensing member, an input device capable of calculating output data of a predetermined output direction and providing improved feel of operation can be obtained by flexibly setting a predetermined rotation angle.

Furthermore, the predetermined output direction may be obtained from output directions of at least two mutually orthogonal axes, and the sensing member may be disposed on the disposition member in a manner allowing independent sensing of each direction of two mutually orthogonal axes obtained by rotating the output directions of the at least two axes by a degree identical to the predetermined rotation angle.

With the above described configuration, areas (saturation areas) in which output values become constant are also generated at least in mutually orthogonal sensible directions in two-dimensional space. Also in this case, since the position of the saturation areas can be set to predetermined locations by setting the rotation angle to a predetermined angle, an input device capable of providing improved feel of operation can be obtained by flexibly setting the predetermined rotation angle.

Furthermore, the sensing member may be rotated and disposed on the disposition member such that a direction, sensed by the sensing member and resulting in the largest absolute values of both output data of the output directions of the two axes, approaches the predetermined output direction.

With the above described configuration, a direction sensed in an area (saturation area) at which a largest output value is obtained at least for both directions of the two mutually orthogonal axis in two-dimensional space, will approach the predetermined output direction. With this, it is possible to improve feel of operation of an operator who frequently conducts an input operation in the predetermined output direction.

Furthermore, the predetermined rotation angle may be about 45 degrees.

With the above described configuration, when resolution of analog-to-digital conversion and the sensing member configured to sense a change of input operation in at least two orthogonal axis directions in two-dimensional space are the same, output values for a load inputted in the saturation areas reach the same upper limit value, and an output direction therefrom matches the predetermined output direction when the output values are combined. Thus, when a large input is made in the saturation areas, it is calculated as an input in the predetermined output direction. With this, it is possible to improve feel of operation of an operator who frequently conducts an input operation in the predetermined output direction.

Furthermore, the sensing member may be strain sensors, capable of sensing an opposing direction when one pair thereof are disposed opposingly, opposingly disposed at each direction derived through rotating the output directions of the two axes by a degree identical to the predetermined rotation angle to obtained two mutually orthogonal axes.

With the above described configuration, strain sensors, a representative example of the sensing member, are used to enable sensing of changes in input operation in two mutually independent axis directions.

Furthermore, the data processor may output the output data to an information processing apparatus in accordance with a request from the information processing apparatus, and the information processing apparatus may execute an application using the output data.

With the above described configuration, since the output data of the predetermined output direction is outputted from the input device, the information processing apparatus can execute an application by directly using the data.

Furthermore, the output data may be used for executing an application, and the predetermined output direction may be at least one direction among upward, downward, rightward, and leftward set in the application.

With the above described configuration, it is possible to match the direction whose output value becomes constant due to saturation occurred in the sensing member with the predetermined output direction, by rotating the direction sensible by the sensing member from the predetermined output direction by a degree identical to the predetermined angle. Furthermore, by setting, in the settings of the application, the predetermined output direction to one of upward, downward, rightward, and leftward in which an operator conducts an operation most frequently, an input device capable of improving feel of operation can be obtained.

Furthermore, the output data may be used for executing the application, and the output directions of the two axes are up-down direction and right-left direction set in the application.

With the above described configuration, by rotating the directions of two orthogonal axes of the input operation sensible by the sensing member, from the output directions of the predetermined two orthogonal axes by a degree identical to the predetermined angle, it is possible to flexibly change the saturation areas in which an output value becomes constant due to saturation of the sensing member. Furthermore, by setting in the settings of the application, the output directions of the two predetermined orthogonal axes to up-down direction and right-left direction in which an operator conducts an operation most frequently, an input device capable of improving feel of operation can be obtained. Furthermore, by setting the predetermined rotation angle to 45 degrees, a large input in the saturation areas is calculated as an input in the up-down direction and the right-left direction in the setting of the application, and thereby feel of operation can be improved for an operator who frequently conducts an input operation upward, downward, rightward, and leftward.

Furthermore, the application may be a game application.

With the above described configuration, it is possible to improve feel of operation of an operator by using the input device in a game application in which an input upward, downward, rightward, or leftward in the setting in the application is frequently requested for operations such as moving a game character etc.

In the description provided above, an input device is used as an example of the configuration of the present embodiment. However, the present embodiment may be formed as an information processing system including an input device and an information processing apparatus, a computer-readable storage medium having stored thereon an information processing program, or an information processing method.

With the present embodiment, it is possible to provide an input device or the like capable of improving feel of operation.

These and other objects, features, aspects and advantages of the present embodiment will become more apparent from the following detailed description of non-limiting example embodiments when taken in conjunction with the accompanying drawings.

### BRIEF DESCRIPTION OF THE DRAWINGS

FIG. 1 is an exploded perspective view showing a non-limiting example of a pointing stick 1 according to the present embodiment;

FIG. 2 shows a non-limiting example of the arrangement of strain sensors according to the present embodiment;

FIG. 3 is for describing a non-limiting example of saturation areas obtained when using the strain sensors shown in FIG. 2;

FIG. 4 shows a non-limiting example of a load within one of the saturation areas shown in FIG. 3;

FIG. 5 is a block diagram showing a non-limiting example of a detector 100 and a peripheral according to the present embodiment;

FIG. 6 is a view of hitherto-known art showing one example of the conventional arrangement of strain sensors;

FIG. 7 is a view of hitherto-known art for describing saturation areas obtained from the arrangement of the strain sensors shown in FIG. 6; and

FIG. 8 shows one example of a load within one of the saturation areas shown in FIG. 7.

### DETAILED DESCRIPTION OF NON-LIMITING EXAMPLE EMBODIMENTS

Configuration of Pointing Stick 1

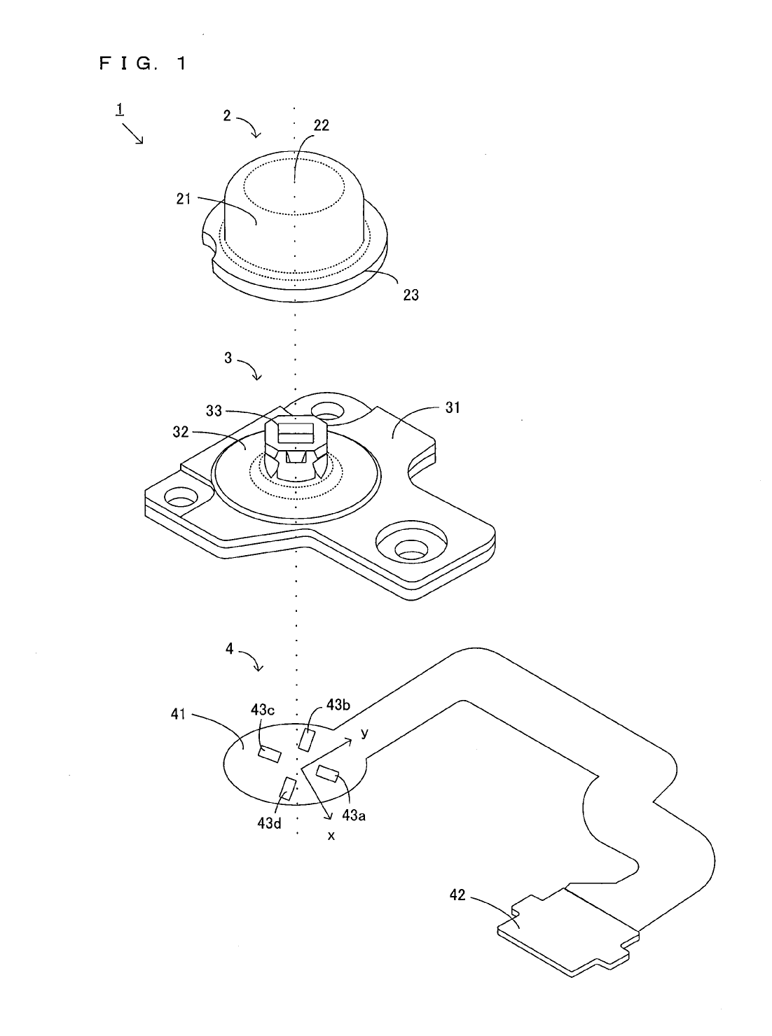

With reference to FIG. 1, an input device (hereinafter, referred to as a pointing stick) according to one embodiment will be described. FIG. 1 is an exploded perspective view showing a pointing stick 1. The pointing stick 1 is attached to a terminal apparatus (not shown), and, in FIG. 1, the upper side indicates an operation surface direction of the terminal apparatus and the lower side indicates a lower surface direction of the terminal apparatus. With regard to components of the below described pointing stick 1, description of components that are not particularly relevant for describing the present embodiment is omitted or simplified.

The pointing stick 1 is attached to the terminal apparatus, and functions as an input device for receiving an input by an operator. As shown in FIG. 1, the pointing stick 1 includes a cap 2, an operation body 3, and a sensor circuit-board 4.

The cap 2 is formed from an elastic body, and is obtained by integrally forming a circumferential surface part 21 formed in an approximately cylindrical form, a top surface part 22 blocking the upper opening of the circumferential surface part 21, and a flange 23 extending outward from an outer peripheral edge of an opening at a lower end side of the circumferential surface part 21. On the upper surface of the top surface part 22, an operation part (not shown) for receiving an operation by the operator is formed. It should be noted that the flange 23 is embedded in the terminal apparatus to prevent the cap 2 from detaching off a later described operation stick 33.

The operation body 3 is formed from a resin, a heat-resistant ceramic material, or the like, and is obtained by integrally forming a base 31, an approximately circular pedestal part 32 formed on the base 31, and a square pillar shaped operation stick 33 described above formed so as to stand upright on the pedestal part 32.

The sensor circuit-board 4 is formed from a flexible resin film or the like, and, has, on one end thereof, an approximately circular base end 41 fixed on the rear surface of the operation body 3 so as to correspond to the position of the pedestal part 32 of the operation body 3. Furthermore, a connector 42 is provided on the other end of the sensor circuit-board 4.

On the base end 41 of the sensor circuit-board 4, strain sensors 43 (43a to 43d) including thick-film or thin-film resistors are formed. The base end 41 on which the strain sensors 43 is formed is adhered and fixed at the position of the rear surface of the pedestal part 32 on the operation body 3 having the operation stick 33 formed thereon. Therefore, when the operation stick 33 is tilted, the strain sensors 43 disposed at the lower part of the operation stick 33 is subjected to compressive force acting in the tilt direction of the operation stick 33 and tensile force acting in the opposite direction of the tilt direction of the operation stick 33. Furthermore, when the strain sensors 43 is subjected to compressive force, its resistance value becomes lower, and when strain sensors 43 is subjected to tensile force, its resistance value becomes higher. Thus, by disposing the strain sensors 43 in appropriate directions, signals indicating the direction and magnitude of the tilt acting on the operation stick 33 can be detected. The present embodiment is characteristic in the arrangement of the strain sensors 43, and this characteristic arrangement will be described in detail later.

The cap 2 is attached to the upper end of the operation stick 33 of the operation body 3 to which the sensor circuit-board 4 is adhered and fixed. Specifically, the cap 2 has a square pillar shaped hollow part formed by the cylindrical circumferential surface part 21 and the top surface part 22. Since the cap 2 is formed from an elastic body, the hollow part can elastically deform. The internal diameter of the hollow part is set to be smaller than a minimum outer diameter of the operation stick 33. Therefore, the cap 2 can be press-fitted on the operation stick 33 utilizing elasticity of the cap 2, and the circumferential surface part 21 is pressed and fitted on the operation stick 33 so as to be attached and fitted on the upper end of the operation stick 33. The pointing stick 1 formed as described above is attached on the terminal apparatus. The operator can, for example, hold portions to the right and left of the terminal apparatus, and operate the pointing stick 1 with a finger while viewing a display screen. Specifically, for example, when the operator operates the operation part (not shown) of the cap 2 upward, the operation stick 33 is tilted in the upward direction, and the magnitude of the tilt in the upward direction is sensed in accordance with an amount of strain on the strain sensors 43 provided on the lower part of the operation stick 33. Then, the terminal apparatus moves and displays, for example, a cursor in the upward direction on a display screen in response to the sensed input in the upward direction.

An analog input device such as a pointing stick has the following problem known in the art. That is, although analog data sensed by an analog input device is amplified at a certain amplifier gain (amplification factor of an amplifier) by an amplifier, when the amplified analog data exceeds a determined input upper limit, the output value will not further change when using an analog-to-digital converter having a predetermined resolution. As a result, a situation occurs where the output value outputted as the magnitude of the input to the analog input device does not change even when the operator is changing a value (input value) of load to the pointing stick. In order to solve this problem, it is conceivable to set the amplifier gain small and prevent the amplified analog data from exceeding the input upper limit However, in this case, while the effective range for the input (range of load) becomes larger, change in the output value when a small load is applied becomes small since resolution of the conversion by the analog-to-digital converter is not changed, resulting in an input device having low sensitivity against a small load. Therefore, it is not possible to simply set the amplifier gain small. Although it is conceivable to increase the resolution of the analog-to-digital converter in order to ensure sufficient sensitivity against a small load, a larger resolution results in a problem of higher cost.

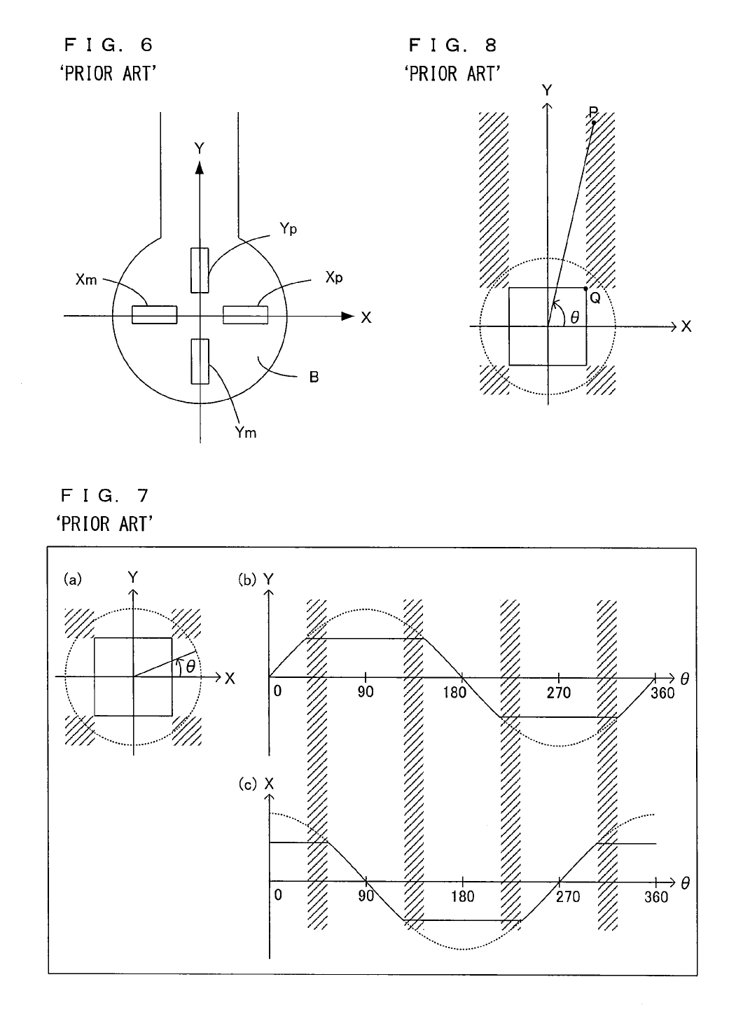

In the present embodiment, in order to solve the above described problem, the arrangement of the strain sensors 43 is different from the conventional arrangement. Here, for comparison, the arrangement and problems of the strain sensors in a conventional pointing stick are described specifically using FIG. 6 to FIG. 8. FIG. 6 is a view of hitherto-known art showing one example of the conventional arrangement of strain sensors, FIG. 7 is a view of hitherto-known art for describing saturation areas obtained from the strain sensors shown in FIG. 6, and FIG. 8 shows one example of a load within one of the saturation areas shown in FIG. 7.

As shown in FIG. 6, strain sensors Xp, Xm, Yp, and Ym are disposed on a circuit board B. The strain sensors Xp and Xm are opposingly disposed in the X-axis direction for sensing a change of input operation in the X-axis direction. The strain sensors Yp and Ym are opposingly disposed in the Y-axis direction for sensing a change in an input operation in the Y-axis direction.

Here, the respective strain sensors are sensors of the same type. Analog data sensed therein is amplified at the same amplifier gain, and analog-to-digital converted by the same analog-to-digital converter with a predetermined resolution. When digital data obtained by the conversion reaches a predetermined output upper limit value, the output value will not change further (strain sensor saturation). Specifically, the area within a square drawn with a solid line shown in (a) of FIG. 7 is an area in which the strain sensors can sense a change of input operation in the X-axis direction and the Y-axis direction and can output a change of direction and magnitude of the input operation (hereinafter, referred to as an outputable area). Outside this area is an area in which a change of input operation at least in the X-axis direction or the Y-axis direction cannot be sensed, and areas shown with diagonal lines in (a) of FIG. 7 are areas in which a change of the input operation cannot be sensed either in the X-axis direction or the Y-axis direction (hereinafter, referred to as saturation areas).

Here, a case will be discussed in which, on a pointing stick having disposed therein the sensors shown in FIG. 6, the operation stick is rotated counterclockwise from the X-axis positive direction to generate a load with a magnitude beyond the outputable area. Specifically, a case will be discussed in which a load is applied having a certain magnitude shown with a perimeter of a circle drawn with a dotted line as shown in (a) of FIG. 7. Here, (b) of FIG. 7 is a graph showing the relationship between an angle θ rotated counterclockwise from the X-axis positive direction shown in (a) of FIG. 7 and an output value in the Y-axis direction outputted as the magnitude of the input to the pointing stick. Furthermore, (c) of FIG. 7 is a graph showing the relationship between an angle θ rotated counterclockwise from the X-axis positive direction shown in (a) of FIG. 7 and an output value in the X-axis direction outputted as the magnitude of the input to the pointing stick. In (b) and (c) of FIG. 7, a graph shown by a dotted line indicates a load actually inputted to the pointing stick, and a graph shown by a solid line indicates an output value that is actually outputted as the magnitude of the input to the pointing stick. It should be noted that, in the description above, although a case in which the operation stick is rotated counterclockwise from the X-axis positive direction is provided, the operation stick can be tilted instead of being rotated. In this case, an angle formed between the X-axis positive direction and the direction in which the operation stick is tilted and measured counterclockwise from the X-axis positive direction is the angle θ described above.

As can be understood from the graph in (b) of FIG. 7, with regard to the output value in the Y-axis direction, since the inputted load has a magnitude outside the outputable area in ranges of the angle θ from around 45 degrees to around 135 degrees and from around 225 degrees to around 315 degrees, the strain sensors Yp and Ym for sensing an input in the Y-axis direction are saturated, and the output value becomes a certain output upper limit value.

Furthermore, as can be understood from the graph in (c) of FIG. 7, with regard to the output value in the X-axis direction, since the inputted load has a magnitude outside the outputable area in ranges of the angle θ from 0 degrees to around 45 degrees, from around 135 degrees to around 225 degrees, and from around 315 degrees to 360 degrees, the strain sensors Xp and Xm for sensing an input in the X-axis direction are saturated, and the output value becomes a certain output upper limit value.

Therefore, when the angle θ is around 45 degrees, around 135 degrees, around 225 degrees, and around 315 degrees (areas with diagonal lines shown in (b) and (c) of FIG. 7), strain sensors for sensing both the X-axis direction and the Y-axis direction are saturated, entering the saturation areas in which the output value does not change either in the X-axis direction or the Y-axis direction (i.e., the output value is fixed to the output upper limit value). Therefore, in the diagonal-line areas, even though the actually inputted direction and magnitude of the load value have changed, an angle of 45 degrees, 135 degrees, 225 degrees, or 315 degrees is outputted as the direction of the input conducted against the pointing stick as a result of combining the output upper limit value in the X-axis direction and the output upper limit value in the Y-axis direction. That is, when an input with a load value in a diagonal-line area (saturation area) shown in (a) of FIG. 7 is conducted, since an output value indicated by each vertex of the square of the outputable area is outputted, the output direction is calculated as a diagonal direction. More specifically, as shown in FIG. 8, even when an input almost in the Y-axis positive direction shown by point P in the saturation area is conducted, the output value actually outputted as an input against the pointing stick is a value indicated by point Q. Therefore, the output direction outputted as the tilt direction of the pointing stick is a direction 45 degrees counterclockwise from the X-axis direction.

Thus, even when the operator conducts a strong input against the pointing stick in the X-axis direction or the Y-axis direction to instruct for an input in that direction, if the input direction slightly deviates from the X-axis direction or the Y-axis direction, the output direction outputted as the tilt direction of the pointing stick becomes a diagonal direction and not the X-axis direction or the Y-axis direction. As a result, a problem occurs where the feel of operation deteriorates for an operator who commonly conducts inputs in the X-axis direction and the Y-axis direction frequently.

### Arrangement of Strain Sensors 43 in the Present Embodiment

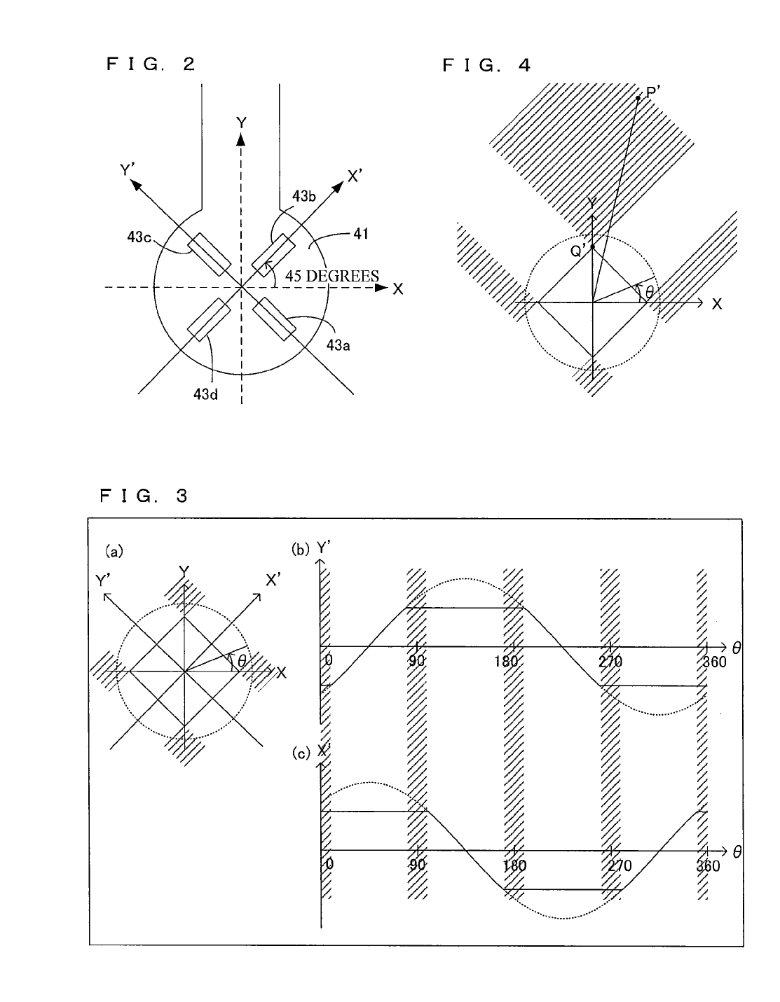

Next, the arrangement of the strain sensors in the present embodiment will be set described by using FIG. 2 to FIG. 4. FIG. 2 shows one example of an arrangement of the strain sensors 43, FIG. 3 is for describing saturation areas of the strain sensors shown in FIG. 2, and FIG. 4 shows one example of a load within one of the saturation areas shown in FIG. 3.

As shown in FIG. 2, the strain sensors 43 (43a to 43d) are disposed on the sensor circuit-board 4. Here, when the output directions outputted as the tilt direction of the pointing stick 1 (the operation stick 33) are the X-axis direction and the Y-axis direction, the strain sensors are opposingly disposed in an X′-axis direction and a Y′-axis direction obtained by rotating the X-axis direction and the Y-axis direction counterclockwise by 45 degrees. Specifically, the strain sensors 43b and 43d are opposingly disposed on the X′-axis direction for sensing a change in the input operation in the X′-axis direction. Furthermore, the strain sensors 43a and 43c are opposingly disposed in the Y′-axis direction for sensing a change in the input operation in the Y′-axis direction.

It should be noted that the strain sensors 43a to 43d are identical sensors. Analog data sensed therein is amplified at the same amplifier gain, and analog-to-digital converted by the same analog-to-digital converter with a predetermined resolution. When digital data obtained by the conversion reaches a predetermined output upper limit value, the output value will not change further (strain sensor saturation). Specifically, the area within a square drawn with a solid line shown in (a) of FIG. 3 is the outputable area in which the strain sensors 43 can sense a change of input operation in the X′-axis direction and the Y′-axis direction and can output a change of direction and magnitude of the input operation. Outside this area is an area in which a change of input operation at least in the X′-axis direction or the Y′-axis direction cannot be sensed, and areas shown with diagonal lines in (a) of FIG. 3 are saturation areas in which a change of input operation cannot be sensed either in the X′-axis direction or the Y′-axis direction.

Here, a case will be discussed in which, on the pointing stick 1 having disposed therein the strain sensors 43 shown in FIG. 2, the operation stick 33 is rotated counterclockwise in the X-axis positive direction to generate a load with a magnitude beyond the outputable area. Specifically, a case will be discussed in which a load having a certain magnitude shown with a perimeter of a circle drawn with a dotted line as shown in (a) of FIG. 3 is applied. Here, (b) of FIG. 3 is a graph showing the relationship between an angle θ rotated counterclockwise from the X-axis positive direction shown in (a) of FIG. 3 and an output value in the Y′-axis direction outputted as the magnitude of the input to the pointing stick 1. Furthermore, (c) of FIG. 3 is a graph showing the relationship between an angle θ rotated counterclockwise from the X-axis positive direction shown in (a) of FIG. 3 and an output value in the X′-axis direction outputted as the magnitude of the input to the pointing stick 1. In (b) and (c) of FIG. 3, a graph shown by a dotted line indicates a load actually inputted to the pointing stick 1, and a graph shown by a solid line indicates an output value that is actually outputted as the magnitude of the input to the pointing stick 1. It should be noted that, in the description above, although a case in which the operation stick is rotated counterclockwise from the X-axis positive direction is provided, the operation stick can be tilted instead of being rotated. In this case, an angle formed between the X-axis positive direction and the direction in which the operation stick is tilted and measured counterclockwise from the X-axis positive direction is the angle θ described above.

Here, as can be understood from (a) of FIG. 3, the outputable range (the range indicated by the square drawn with a solid line) is obtained by rotating the outputable range of a conventional pointing stick (cf. (a) of FIG. 7) by 45 degrees in direction θ. Therefore, the graph in (b) of FIG. 3 and the graph in (c) of FIG. 3 are obtained respectively through parallel movement of the graph in (b) of FIG. 7 and the graph in (c) of FIG. 7 by 45 degrees in direction θ. Therefore, as can be understood from the graph in (b) of FIG. 3, with regard to the output value in the Y′-axis direction, since the inputted load has a magnitude outside the outputable area in ranges of the angle θ from around 90 degrees to around 180 degrees and from around 270 degrees to 360 degrees, the strain sensors 43a and 43c for sensing an input in the Y′-axis direction are saturated, and the output value becomes a certain output upper limit value.

Furthermore, as can be understood from the graph in (c) of FIG. 3, with regard to the output value in the X′-axis direction, since the inputted load has a magnitude outside the outputable area in ranges of the angle θ from 0 degrees to around 90 and from around 180 degrees to around 270 degrees, the strain sensors 43b and 43d for sensing an input in the X′-axis direction are saturated, and the output value becomes a certain output upper limit value.

Therefore, when the angle θ is around 0 degrees (360 degrees), around 90 degrees, around 180 degrees, around 270 degrees, and around 360 degrees (areas with diagonal lines shown in (b) and (c) of FIG. 3), the strain sensors 43a to 43d for sensing both the X′-axis direction and the Y′-axis direction are saturated, entering the saturation areas in which the output value does not change either in the X′-axis direction or the Y′-axis direction (i.e., the output value is fixed to the output upper limit value). Therefore, in the diagonal-line areas, even though the actually inputted direction and magnitude of the load value have changed, an angle of 0 degrees (360 degrees), 90 degrees, 180 degrees, or 270 degrees is outputted as the direction of the input conducted against the pointing stick 1 as a result of combining the output upper limit value in the X′-axis direction and the output upper limit value in the Y′-axis direction. That is, when an input with a load value in a diagonal-line area (saturation area) shown in (a) of FIG. 3 is conducted, since an output value indicated by each vertex of the square of the outputable area is outputted, the output direction is calculated as the X-axis direction or the Y-axis direction. More specifically, as shown in FIG. 4, even when an input almost in the Y-axis positive direction shown by point P′ in the saturation area is conducted, the output value actually outputted as an input against the pointing stick 1 is a value indicated by point Q′. Therefore, the output direction outputted as the tilt direction of the pointing stick 1 is the Y-axis positive direction.

Thus, when the operator conducts a strong input against the pointing stick in the X-axis direction or the Y-axis direction to instruct for an input in that direction, even if the input direction slightly deviates from the X-axis direction or the Y-axis direction, the X-axis direction or the Y-axis direction becomes the output direction outputted as the tilt direction of the pointing stick. As a result, there will not be any problems of deterioration of the feel of operation for an operator who commonly conducts inputs in the X-axis direction and the Y-axis direction frequently. It should be noted that, when arranging the strain sensors 43, it is not necessary to precisely rotate the strain sensors 43 by 45 degrees, and the above described operations and effects can be obtained even when the strain sensors are rotated approximately at 45 degrees to be arranged.

Configuration of Detector

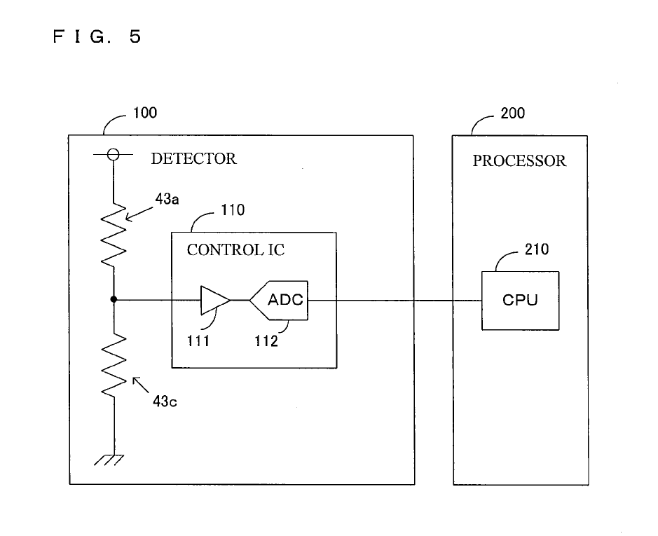

Next, description will be provided for a detector 100 of the sensor circuit-board 4 in the pointing stick 1 of the present embodiment, using FIG. 5. FIG. 5 is a block diagram showing the configuration of the detector 100 and a peripheral. The detector 100 is formed from the strain sensors 43 (resistors) and a control IC 110, and the control IC 110 includes an amplifier 111 and an analog-to-digital converter 112.

Sense current is caused to flow through the strain sensors 43. When a strain sensor is strained, its resistance value changes to thereby change the current value, and the value is outputted to the control IC 110 as analog data. In addition, since the strain sensors 43 are opposingly disposed as a pair, a change in operation in a direction can be sensed from the strain in the opposing direction. It should be noted that although described in FIG. 5 is a case where the strain sensors 43a and 43c are opposingly disposed as the strain sensors 43 for sensing a change in operation in the Y′-axis direction shown in FIG. 2, the same applies for a case where the strain sensors 43b and 43d are opposingly disposed for sensing a change in operation in the X′-axis direction. In this manner, the strain sensors 43 independently sense changes in the X′-axis direction and the Y′-axis direction.

The amplifier 111 of the control IC 110 amplifies the inputted analog data at a predetermined amplification factor (amplifier gain), and outputs the amplified data to the analog-to-digital converter 112. The analog-to-digital converter 112 converts the amplified analog data to digital data at a predetermined resolution, and outputs the converted data to a CPU 210.

By executing a common program, the CPU 210 executes an arithmetic process of rotational conversion on the inputted digital data (sense data). Specifically, since the inputted digital data are data regarding changes in the X′-axis direction and the Y′-axis direction, these data are converted so as to be rotated by minus 45 degrees in direction θ (a conversion of clockwise rotation by 45 degrees) to be converted into data regarding changes in the X-axis direction and the Y-axis direction which are output directions outputted as the tilt direction of the pointing stick 1. Therefore, when the output value of the X-axis direction is defined as X_output, when the output value of the Y-axis direction defined as Y_output, when digital data sensed by the strain sensors 43b and 43d disposed in the X′-axis direction and converted in an analog-to-digital manner is defined as f(X′), and when digital data sensed by the strain sensors 43a and 43c disposed in the Y′-axis directions and converted in an analog-to-digital manner is defined as f(Y′); an arithmetic process provided by the following calculation formulae is executed.

$$\begin{matrix}X\_output = \frac{f ( {X}^{′} ) - f ( {Y}^{′} )}{\sqrt{2}} & ( 1 ) \\ Y\_output = \frac{f ( {X}^{′} ) + f ( {Y}^{′} )}{\sqrt{2}} & ( 2 )\end{matrix}$$

Then, the CPU 210 executes various applications by executing each application program using the calculated data (output data).

Here, description will be provided regarding a case in which the terminal apparatus is a portable game apparatus, and a game application is executed as a representative example of the applications. When the game application is executed in the portable game apparatus, for example, a game character is moved in accordance with the operation conducted on the pointing stick 1. In this case, associated with the execution of the game application, the portable game apparatus requests, to the pointing stick 1, output data indicating the direction and magnitude of the operational input conducted against the pointing stick 1. The CPU 210 of the pointing stick 1 that received the request outputs output data calculated based on the change in the strain sensors 43 by the arithmetic expressions (1) and (2). At this point, since changes of magnitude in the X-axis direction and the Y-axis direction shown in FIG. 2 are outputted as output data, the output directions (X-axis direction and Y-axis direction) of the pointing stick 1 are preferably set such that the right-left direction set in the game application matches the X-axis direction shown in FIG. 2, and the up-down direction set in the game application matches the Y-axis direction shown in FIG. 2. By setting the output directions in such manner, when the strain sensors 43 are saturated as described above, the output direction is calculated as the X-axis direction or the Y-axis direction (cf. (a) of FIG. 3), and thereby an output is generated assuming there has been an input in the right-left direction or the up-down direction set in the game application. With this, it is possible to improve operability of the operator for operations of frequently making inputs in the up-down direction and the right-left direction as in the case of operations conducted when the game application is executed.

Furthermore, it is possible to match the output direction when the strain sensors 43 are saturated to the output direction of the pointing stick 1 set above, by appropriately setting the output direction of the pointing stick 1 as described above and rotationally arranging the strain sensors 43 with respect to the output direction by a rotation angle of 45 degrees. Thus, by matching the output direction of the pointing stick 1 to an effective direction in the setting of the game application, the game application can be executed by directly using the output value from the pointing stick 1.

As described above, although an analog input device such as the pointing stick 1 has a problem where a saturation area is generated, the present embodiment enables the position of the saturation area to be changed to a position different from the conventional position, by arranging the strain sensors 43 so as to be rotated from the predetermined output direction. Furthermore, since a load within the saturation area is outputted as an output value indicated by each of the vertices of the outputable area, by rotating the outputable area such that each of the vertices of the outputable area is pointed toward a predetermined output direction (i.e., rotationally arrange the strain sensors 43), it is possible to set, to a predetermined output direction, the tilt direction of the pointing stick 1 outputted when the strain sensors 43 are saturated. By setting a direction in which the operator frequently conducts an operation as the predetermined output direction, it is possible to provide an input device that improves the feel of operation without increasing the predetermined resolution of the analog-to-digital converter.

It should be noted that the embodiment described above is merely one example, and does not limit the scope of the exemplary embodiments described herein in any way.

Furthermore, in the embodiment described above, although description is provided for the pointing stick 1 shown in FIG. 1 as one example, the material and shape of the pointing stick 1 are merely examples, and it is possible to attain the pointing stick 1 with other materials and shapes.

Furthermore, in the above described embodiment, although an example has been described in which the analog input device is the pointing stick 1, and magnitude and direction of input conducted thereto is sensed by the strain sensors 43; sensing members other than the strain sensors 43 may be used as long as magnitude and direction of input conducted against the analog input device can be sensed. Furthermore, if the sensing member can sense an input in one direction, it is not necessary to opposingly disposed one pair thereof as in the case with the strain sensors 43. With such a sensing member, a pair of sensors does not have to be rotationally arranged together as a unit as in the above described embodiment, and the sensing member itself may be rotated on the spot to be arranged.

Furthermore, in the above described embodiment, since a load in the saturation area is outputted as an output value indicated by each of the vertices of the outputable area (square), the strain sensors 43 are rotationally arranged by 45 degrees in order to match the direction of the load in the saturation area with the X-axis direction or the Y-axis direction (cf. (a) of FIG. 3). However, the direction outputted as the tilt direction of the pointing stick 1 when a load in the saturation area is applied may be any desired direction. Therefore, the strain sensors 43 may be rotated by a desired angle and arranged so as to have each of the vertices of the outputable area (square) pointed toward the desired direction.

Furthermore, in the above described embodiment, since all the strain sensors 43 are the same type and resolutions of the analog-to-digital converter and the amplifier gain are the same, the outputable area is defined as a square (cf. (a) of FIG. 3). However, analog data sensed in each axial direction (X′-axis direction and Y′-axis direction) may be digitally converted by, for example, an analog-to-digital converter having different resolutions for each of the axial directions. In such a case, since the outputable area is defined not by a square but by a rectangle, the positions of the saturation areas will become different from those of the embodiment described above. Also in such a case, similar to the above described embodiment, since the load in the saturation area is outputted as an output value indicated by each vertex of the outputable area (rectangle), the strain sensors 43 may be rotated by a desired rotation angle such that the vertices are pointed toward a desired direction. It should be noted that, in this case, since it is not possible to have all vertices pointed toward two orthogonal axial directions, the strain sensors 43 may be rotationally arranged such that one of the vertices is pointed toward at least one direction in which the operator conducts an input operation frequently (e.g., up-down direction and right-left direction). Also in such a case, it is possible to improve operability in a direction in which an input operation is conducted frequently.

Furthermore, in the embodiment described above, as shown by formulae (1) and (2), as the arithmetic process, a process of rotational conversion is conducted by a rotation angle identical to the rotation angle for the strain sensors 43 in a direction opposite of the direction in which the strain sensors 43 are rotated from the predetermined output direction (X-axis direction and Y-axis direction). Therefore, an output value in the predetermined output direction is calculated. However, the rotational conversion does not have to be conducted in the opposite direction by the same rotation angle, i.e., the rotational conversion may be conducted in the opposite direction by a different rotation angle such that an output value is calculated in a direction deviated from (but close to) the predetermined output direction (X-axis direction and Y-axis direction).

Furthermore, in the embodiment above, description is provided regarding the strain sensors 43 for sensing directional inputs in two dimensions, i.e., the X′ direction and the Y′ direction. However, instead of the sensors for sensing directional inputs in two dimensions, sensors for sensing directional inputs in three dimensions may be provided. In this case, the sensors may be arranged so as to be rotated from a predetermined output direction (e.g., for X-axis direction, Y-axis direction, Z-axis direction) by a desired rotation angle through rotational conversion in three-dimensional space.

Furthermore, in the above described embodiment, a case has been illustrated in which the output directions (X-axis direction and Y-axis direction) of the pointing stick 1 are set such that the right-left direction set in the game application matches the X-axis direction shown in FIG. 2, and such that the up-down direction set in the game application matches the Y-axis direction shown in FIG. 2. However, it is also possible to match, when the terminal apparatus is held by the operator, the right-left direction of the terminal apparatus to the X-axis direction shown in FIG. 2, and match the up-down direction of the terminal apparatus to the Y-axis direction shown in FIG. 2. Also in this manner, it is possible to improve the feel of operation when input is conducted in the up-down direction and the right-left direction when the operator holds the terminal apparatus. It should be noted that, when the operator operates the pointing stick 1 while holding the terminal apparatus, there are cases where sensation of, for example, the up-down direction operated by the operator is different from the up-down direction of the terminal apparatus depending on the position where the pointing stick 1 is attached. In such cases, a direction different (slightly deviated) from the actual up-down direction of the terminal apparatus may be matched with the Y-axis direction shown in FIG. 2 by taking into consideration the operational sensation of the operator.

While certain exemplary embodiments have been described in detail, the foregoing description is in all aspects illustrative and not restrictive. It will be understood that numerous other modifications and variations can be devised.

What is claimed is:

1. An input device comprising:
an input member;
a sensing member configured to sense a direction of an input operation conducted against the input member;
a disposition member on which the sensing member is disposed; and
a data processor capable of processing sense data sensed based on the sensing member and outputting output data of a predetermined output direction, wherein
the sensing member is disposed on the disposition member such that the direction sensible by the sensing member is rotated by a predetermined rotation angle with respect to the predetermined output direction, and
the data processor is configured to execute an arithmetic process of rotational conversion to rotate the sense data in a direction opposite of a rotation direction of the predetermined rotation angle to output a result of the arithmetic process as output data.

2. The input device according to claim 1, further comprising a converter configured to conduct analog-to-digital conversion of analog data at a predetermined resolution, wherein
the sense data is data obtained through analog-to-digital conversion by the converter conducted on analog data sensed by the sensing member.

3. The input device according to claim 2, wherein the data processor executes an arithmetic process of rotational conversion to rotate the sense data in a direction opposite of a rotation direction of the predetermined rotation angle by a degree identical to the predetermined rotation angle, and outputs the output data.

4. The input device according to claim 3, wherein
the predetermined output direction is output directions of at least two mutually orthogonal axes, and
the sensing member is disposed on the disposition member in a manner allowing independent sensing of each direction of two mutually orthogonal axes obtained by rotating the output directions of the at least two axes by a degree identical to the predetermined rotation angle.

5. The input device according to claim 4, wherein the sensing member is rotated and disposed on the disposition member such that a direction, sensed by the sensing member and resulting in largest absolute values of output data of the output directions of the two axes, approaches the predetermined output direction.

6. The input device according to claim 4, wherein the predetermined rotation angle is about 45 degrees.

7. The input device according to claim 4, wherein the sensing member is strain sensors, capable of sensing an opposing direction when one pair thereof are disposed opposingly, opposingly disposed at each direction derived through rotating the output directions of the two axes by a degree identical to the predetermined rotation angle to obtained two mutually orthogonal axes.

8. The input device according to claim 1, wherein
the data processor outputs the output data to an information processing apparatus in accordance with a request from the information processing apparatus, and
the information processing apparatus executes an application using the output data.

9. The input device according to claim 2, wherein
the output data is used for executing an application, and
the predetermined output direction is at least one direction among upward, downward, rightward, and leftward set in the application.

10. The input device according to claim 4, wherein
the output data is used for executing an application, and
the output directions of the two axes are up-down direction and right-left direction set in the application.

11. The input device according to claim 9, wherein the application is a game application.

12. An information processing system comprising an input device and an information processing apparatus,
the input device including:
an input member;
a sensing member configured to sense a direction of an input operation conducted against the input member;
a disposition member on which the sensing member is disposed; and
a data processor capable of processing sense data sensed based on the sensing member and outputting output data of a predetermined output direction to the information processing apparatus,
the sensing member being disposed on the disposition member such that the direction sensible by the sensing member is rotated by a predetermined rotation angle with respect to the predetermined output direction,
the data processor being configured to execute an arithmetic process of rotational conversion to rotate the sense data in a direction opposite of a rotation direction of the predetermined rotation angle, and output a result of the arithmetic process as output data to the information processing apparatus,
the information processing apparatus including
an information processor configured to conduct a predetermined information process using output data outputted by the data processor.

13. A computer-readable storage medium having stored thereon an information processing program executed by a computer of an input device having disposed therein a sensing member configured to sense a direction of an input operation conducted against an input member, on a disposition member in a rotated manner such that a direction of an input operation sensible by the sensing member is rotated by a predetermined rotation angle with respect to a predetermined output direction,
the program causing the computer to function as a data processor capable of processing sense data sensed based on the sensing member and outputting output data of the predetermined output direction,
the data processor being configured to execute an arithmetic process of rotational conversion to rotate the sense data in a direction opposite of a rotation direction of the predetermined rotation angle, and output a result of the arithmetic process as output data.

14. An information processing method executed by a computer of an input device of having disposed therein a sensing member configured to sense a direction of an input operation conducted against an input member, on a disposition member in a rotated manner such that a direction of an input operation sensible by the sensing member is rotated by a predetermined rotation angle with respect to a predetermined output direction, the method comprising
a data processing step of causing the computer to process sense data sensed based on the sensing member, and outputting output data of the predetermined output direction, wherein
in the data processing step, an arithmetic process is executed to conduct rotational conversion to rotate the sense data in a direction opposite of a rotation direction of the predetermined rotation angle, and output a result of the arithmetic process as output data.
